(19) United States
(12) Patent Application Publication
(10) Pub. No.: US 2026/0331817 A1
(43) Pub. Date: Oct. 22, 2026

(54) CONTACT INSERT FOR PLUG CONNECTOR

(71) Applicant: Phoenix Contact GmbH & Co. KG, Blomberg (DE)

(72) Inventors: Lukas BRILLO, Höxter (DE); Roberto GILARDONI, Paderborn (DE); Thorsten DIESSEL, Hiddenhausen (DE)

(21) Appl. No.: 19/109,572

(22) PCT Filed: Sep. 14, 2023
(86) PCT No.: PCT/EP2023/075267

§ 371 Date: Mar. 7, 2025

(30) Foreign Application Priority Data
Sep. 28, 2022 (BE) 2022/5773

(51) Int. Cl. H01R 13/506

(52) U.S. Cl. CPC H01R 13/506

(57) ABSTRACT

A contact insert for a connector includes: an insulating body in which a plurality of contact elements are arranged, the insulating body having two mutually opposing longitudinal sides and two mutually opposing end sides; at least one shoulder; and at least one latching element for latching the contact insert in place in a housing part of a connector being disposed on each mutually opposing end side of the two mutually opposing end sides. The at least one latching element may be brought from a first position into a second position.

### CROSS-REFERENCE TO PRIOR APPLICATIONS

This application is a U.S. National Phase application under 35 U.S.C. § 371 of International Application No. PCT/EP2023/075267, filed on Sep. 14, 2023, and claims benefit to Belgian Patent Application No. BE2022/5773, filed on Sep. 28, 2022. The International Application was published in German on Apr. 4, 2024 as WO 2024/068289 A 1 under PCT Article 21(2).

### FIELD

The invention relates to a contact insert for a connector, having an insulating body in which a plurality of contact elements are arranged, the insulating body having two mutually opposing longitudinal sides and two mutually opposing end sides. Moreover, the invention also relates to an assembly composed of a contact insert and a housing part of a connector, the housing part being configured to receive the contact insert.

### BACKGROUND

The purpose of contact inserts for connectors, in which a plurality of contact elements are arranged, is to be coupled to a corresponding mating contact insert that is disposed in a housing of a mating connector. The contact elements may in particular be contact pins or contact sockets, which are connected to corresponding contact elements of the mating contact insert when the contact insert is mated with a corresponding mating connector.

Contact inserts can be divided into modular contact inserts and contact inserts with a fixed number of positions. Generally, modular contact inserts are first inserted into a holding frame, which is then inserted into and secured in a housing part of the connector. Because the contact inserts can be individually inserted into the holding frame, it is possible to equip a holding frame with different contact inserts, depending on the application. However, because of the necessity of using a holding frame and the use of individual contact inserts, the contact density in a connector having a modular design is lower than in a contact insert with a fixed number of positions and comparable external dimensions.

In contrast, contact inserts which have a fixed number of positions, i.e., where no holding frame is used, are directly inserted into and secured in a housing part of a connector. Such a contact insert has an insulating body in which a plurality of contact elements are arranged. Moreover, generally, a flange portion is disposed on each of two mutually opposing end sides of the insulating body, the flange portion being used for positioning and securing the contact insert in the housing part of a connector. Since the number of contact elements disposed in the insulating body of such contact inserts cannot be changed, these contact inserts are referred to as contact inserts with a fixed number of positions.

Generally, the contact inserts also have at least one ground terminal, which is disposed in the region of a flange portion, because the flange portion is usually at least partially made of metal or includes a stamped and formed metal part to which the ground terminal is electrically conductively connected. The metal part also serves to electrically connect the contact insert to a metallic connector housing, so that protective grounding of the housing can be accomplished via the ground terminal. In the case of a connector housing made of plastic and having a grounding bridge, the metal part serves to make connection to the grounding bridge, via which two ground terminals of a contact insert are electrically interconnected, in order to ensure that when the connector and the mating connector are mated, the safety ground contact is established first. If the contact insert is mounted in the housing of a connector, the ground terminal also establishes an electrically conductive connection to the mating contact insert mounted in the housing of the mating connector, so that the contact insert and the mating contact insert are at the same potential when in the mated condition.

Various types of contact inserts with a fixed number of positions have been known in the field for many years. These contact inserts differ in particular in the type, number, and arrangement of the contact elements. The contact inserts are secured in the housing part of a connector by means of screws. For this purpose, corresponding holes are formed in the flange portions of the contact insert, and respective threaded holes are formed in the housing part. This allows for a mechanically stable and reliable connection of the contact insert in the housing part. However, the disadvantage here is that the assembly process is relatively complex and the associated assembly time is relatively long.

### SUMMARY

In an embodiment, the present invention provides a contact insert for a connector, comprising: an insulating body in which a plurality of contact elements are arranged, the insulating body having two mutually opposing longitudinal sides and two mutually opposing end sides; at least one shoulder; and at least one latching element configured to latch the contact insert in place in a housing part of a connector being disposed on each mutually opposing end side of the two mutually opposing end sides, wherein the at least one latching element is configured to be brought from a first position into a second position.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a perspective view of an exemplary embodiment of two contact inserts;

FIGS. 2a and 2b show a perspective view and a plan view of an exemplary embodiment of a housing part with a contact insert inserted therein;

FIGS. 3a and 3b show two sectional views of the housing part of FIG. 2 with and without an inserted contact insert;

FIGS. 4a, 4b and 4c show a portion of the housing part with an inserted contact insert in longitudinal section, illustrating three different positions of the contact insert;

FIGS. 5a and 5b show two enlarged detail views of a contact insert, one showing the latching element in the first position, and one showing the latching element in the second position.

### DETAILED DESCRIPTION

In an embodiment, the present invention provides a contact insert that can be fitted into a housing part of a connector in a simple manner. The contact insert is capable of being directly inserted into and secured in the housing part without using a holding frame. The contact density is high without increasing the external dimensions of the contact insert. Another embodiment provides an assembly composed of a contact insert and a housing part of a connector, where the contact insert and the housing part can be mechanically connected in as simple a manner as possible.

The contact insert according to the invention has at least one shoulder and at least one latching element on each of the two end sides. The shoulders formed on the end sides of the insulating body cooperate with abutment portions in the housing part of the connector, thereby providing a stop or defined end position for the contact insert during insertion thereof into the housing part. The latching elements can be brought from a first position into a second position and serve to latch the contact insert in place in the housing part of a connector. The first position of the latching element is a locking position, in which the latching element engages in a corresponding latching recess in the opposite end wall of the housing part of the connector. This allows the contact insert to be mechanically secured in the housing part of a connector in a secure and reliable manner without having to thread screws into the housing part, which makes mounting easier and faster to accomplish.

As explained above, at least one shoulder is provided on each of the two end sides of the insulating body. Although in principle it may be sufficient to provide one shoulder on an end side, the contact insert is generally configured to have two shoulders on each of the two end sides. The at least one latching element is then disposed between the shoulders, so that the arrangement of shoulders and latching elements is symmetrical to the central plane of the contact insert. Moreover, the two shoulders are preferably disposed outwardly on the respective end sides, so that the engagement of a contact insert inserted into a housing part occurs in the region of the corners of the insulating body.

With regard to the latching elements disposed on the end sides of the insulating body, it has been previously explained that these latching elements can be brought from a first position into a second position. If the contact insert is inserted in the housing part of a connector, the contact insert can be locked in the housing part by the latching elements each being pivoted into or located in the first position. Pivotable mounting of the latching element on an end side of the insulating body may be accomplished by mounting the latching element so as to be pivotable about a pivot pin extending transversely to insertion direction E on the end wall of the insulating body. In this case, a bearing recess corresponding to the pivot pin is provided into which fits the pivot pin. The pivot pin may be formed either on the latching element or on the end side of the insulating body. Correspondingly, the bearing recess is formed either in the end side of the insulating body or in the latching element. The latching elements may be disposed and formed on the respective end side of the insulating body in such a way that they can be locked in the first position. For this purpose, a latching nose may be formed on the end side of the insulating body, the latching nose latching into place with a corresponding portion of latching element when the latching element is pivoted into the first position.

In accordance with an alternative embodiment, the latching element is formed integrally with the respective end side of the insulating body. The latching element may, for example, be connected via a flexible hinge to the end side of the insulating body. In this case, the insulating body and the latching element are preferably made from a plastic material. It is advantageous if, in addition to the latching elements, the shoulders are also formed integrally with the insulating body, because, in this case, the insulating body is particularly easy to manufacture, in particular by injection molding.

The mounting of the inventive contact insert into a housing part of a connector can be further simplified if the latching elements do not need to be actively brought into their first position by the user, but rather if this occurs automatically during insertion of the contact insert into the housing part. For this purpose, the end side of the insulating body may, for example, have an additional spring element disposed thereon that exerts a spring force on the latching element, urging the latching element into its first position. Thus, in order to pivot the latching element from its first position into its position, a force needs to be applied that counteracts the spring force of the spring element.

In accordance with a preferred embodiment of the inventive contact insert, the latching elements are configured as resilient latching arms, the root portion of each being connected to an end side of the insulating body and the free end thereof having at least one latching nose. The resilient latching arms are disposed on the end side of the insulating body in such a way that, during insertion of the contact insert into the housing part, they are initially deflected toward the end side and then spring back to their first position when the contact insert reaches its defined end position; i.e., when the shoulders on the end sides of the insulating body abut the corresponding abutment portions in the housing part. The latching noses of the latching arms then engage in the corresponding latching recesses in the opposite end walls of the housing part, thereby latching the contact insert securely in place in the housing part. The direction of extent of the latching arms from their root portion to the free end is preferably opposite to the insertion direction E of the contact insert into the housing part. Furthermore, the latching noses preferably have a bevel that rises outwardly in a direction opposite to insertion direction E of the contact insert, so that the contact insert can be easily inserted into the housing part, with the latching arms being deflected by the end walls of the housing part alone.

When the contact insert is to be removed from the housing part, the latching elements must be brought from their first position into their second position, the removal position. In the second position, the latching noses of the latching elements do not engage in the latching recesses in the opposite end walls of the housing part of the connector, so that the contact insert can be easily removed from the housing part. In order for the contact insert to also be removable from the housing part as easily as possible, the latching elements each have an actuating portion for bringing the latching element from the first position into the second position. For this purpose, the actuating portion of the latching element may, for example, be configured as a gripping portion. In this case, the gripping portions of the two latching elements are preferably arranged relative to each other such that a user can operate both gripping portions simultaneously with one hand. This allows the contact insert to be very easily removed from the housing part.

In accordance with an alternative embodiment, the actuating portion is configured as a receptacle for a tool, for example, the tip of a screwdriver. In this case, the latching element can be easily pivoted from the first position into the second position by inserting the tip of the tool into the receptacle and subsequently pivoting the tool. The shape of the receptacle can be used to define whether the latching element can be pivoted with a conventional screwdriver or only with a special tool.

In accordance with a preferred embodiment of the contact insert, where the latching elements are configured as resilient latching arms, the latching elements each have two latching noses which are slightly spaced apart. The actuating portion configured as a receptacle for a tool is formed between the two latching noses, so that the latching noses also serve as a guide for the tip of the tool during insertion of the tool into the receptacle.

As explained at the outset, the contact density of the contact insert according to the invention should be as high a as possible, without increasing the external dimensions of the contact insert as compared to conventional contact inserts. This is preferably achieved in that no metal part serving as a ground terminal is disposed at the two end sides of the insulating body. Because no metal part is disposed at the end sides of the insulating body, the mating face of the contact insert, which is formed by the contact elements, can have an area corresponding to at least 80%, in particular at least 90%, of the maximum external dimension of the contact insert. The maximum external dimension is considered to be the area calculated as the product of the maximum length and the maximum width of the contact insert.

In the case of conventional contact inserts, a not insignificant portion of the maximum external dimension of the contact insert is not available for the contact elements due to the metal parts that are disposed in the region of the flange portions to serve for grounding, and, therefore, the area of the mating face of such contact inserts is generally no more than 70% of the maximum external dimension of the contact insert. By deliberately omitting any metal parts that would be mounted on the end sides of the insulating body to serve as a ground terminal, the contact insert can have a greater number of contact elements with otherwise unchanged external dimensions. This also further simplifies the manufacture of the contact insert because it can be made entirely from plastic, except for the contact elements.

The object stated at the outset is achieved in an assembly composed of an inventive contact insert and a housing part of a connector described herein. The housing part of the connector has two mutually opposing side walls, two mutually opposing end walls, and a plurality of abutment portions on which the contact insert rests with its shoulders when it is inserted in the housing part. The housing part is overall cap-shaped, the internal dimensions thereof being matched to the corresponding external dimensions of the contact insert, at least in cross section.

In accordance with the invention, a latching recess is formed in the inner surface of each of the two end walls of the housing part, a corresponding latching element engaging in a respective one of the latching recesses in its first position when the contact insert is inserted in the housing part. The dimensions of the latching recesses are matched to the dimensions of the latching elements, so that the contact insert is prevented from being pulled out of the housing part in a direction opposite to insertion direction E when the latching elements are in their first position, the locking position.

As explained above, the contact insert according to the invention preferably has two shoulders disposed on each of the two end sides of the insulating body. In this case, the housing part accordingly has two abutment portions formed on each of the two end walls thereof. Analogously to the shoulders, the abutment portions are disposed outwardly on the end walls, in the transition region to the side walls. Since the contact insert is secured in the housing part without requiring screws, no threaded holes need to be formed in the housing part, which also simplifies the manufacture of the housing part.

The inventive contact insert and the assembly composed of the contact insert and the housing part can be embodied and refined in various specific ways. In this context, reference is made to the appended claims and the following description of a preferred exemplary embodiment in conjunction with the drawing, in which:

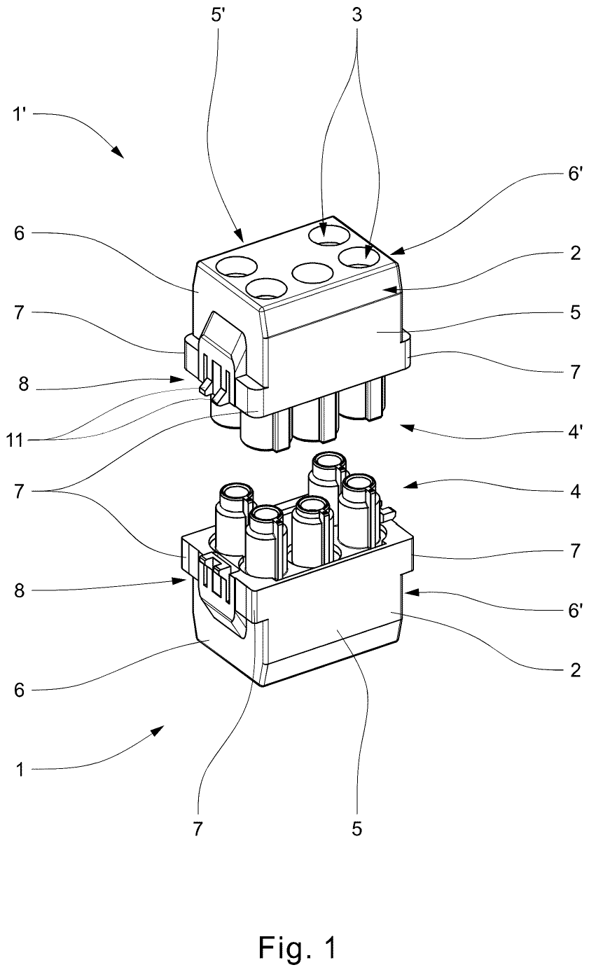

FIG. 1 shows an exemplary embodiment of two corresponding contact inserts 1, 1′ for a connector, the contact inserts 1, 1′ each having an insulating body 2 in which a plurality of contact elements 3 are arranged. The two contact inserts 1, 1′ differ only by the two mating faces 4, 4′, which are configured to correspond to each other, and the contact elements 3 arranged in the respective insulating bodies 2, the contact elements 3 of one contact insert 1 being configured as contact pins, and those of the other contact insert l′ being configured as contact sockets.

Insulating body 2 has two mutually opposing longitudinal sides 5, 5′ and two likewise mutually opposing end sides 6, 6′. Both the number of contact elements 3 and the dimensions of insulating body 2 may differ from the illustrated exemplary embodiment. For example, the extent of longitudinal sides 5, 5′ may be less and that of end sides 6, 6′ may be greater than in the illustrated exemplary embodiment. It is also possible, for example, that the length of end sides 6, 6′ may be equal to or even exceed the length of longitudinal sides 5, 5′.

Two shoulders 7 and a latching element 8 are disposed on each of the two end sides 6, 6′ of insulating body 2, both the shoulders 7 and the latching elements 8 being formed integrally with insulating body 2. The two respective shoulders 7 are disposed outwardly on the two end sides 6, 6′, and latching element 8 is disposed between the two shoulders 7 of an end side 6, 6′.

In the exemplary embodiment shown in the figures, latching elements 8 are configured as resilient latching arms, the root portion 9 of each being connected to a respective end side 6, 6′. Two latching noses 11 are formed at the free end 10 of the latching element 8 or latching arm. The extension of the resilient latching arms from root portion 9 to free end 10 is opposite to the insertion direction E of contact insert 1 into the housing part 20 of a connector.

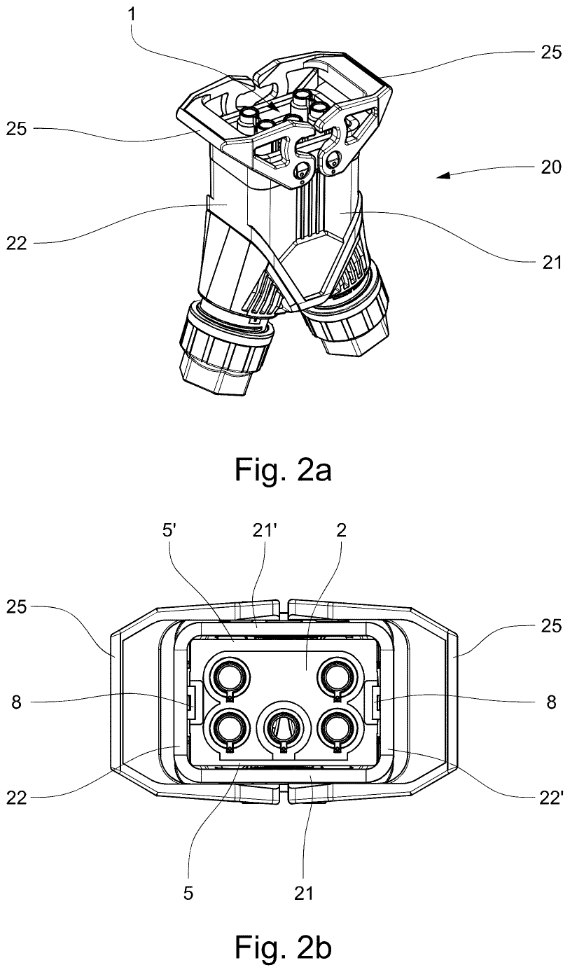

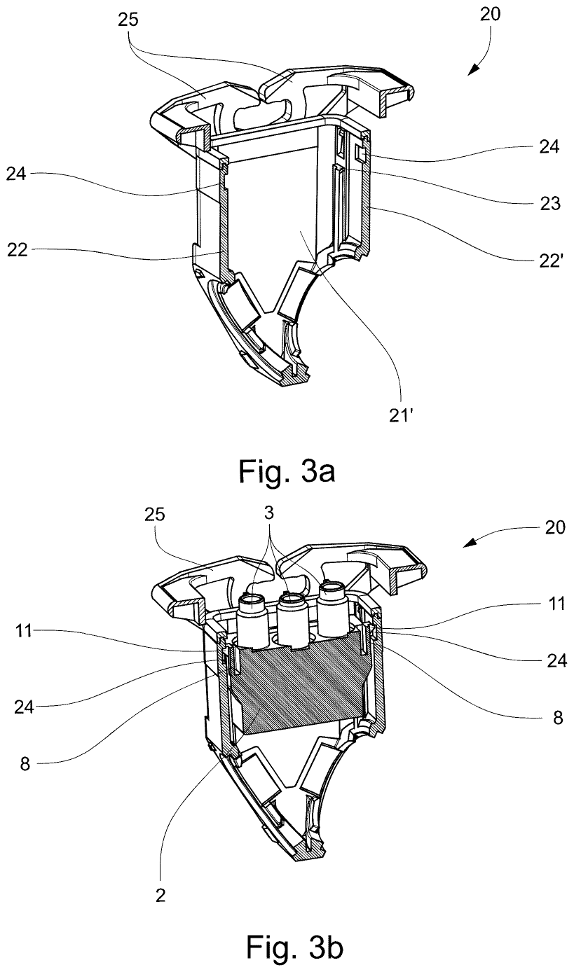

FIG. 2 depicts a perspective view showing such a housing part 20 with an inserted contact insert 1 in the locked state, where the two latching elements 8 are in their first positions. FIG. 3 shows two sectional views of housing part 20, one without an inserted contact insert 1 (FIG. 3a) and one with an inserted contact insert 1 (3b). Housing part 20 has two mutually opposing side walls 21, 21′ and two likewise mutually opposing end walls 22, 22′, which together form a receiving space for contact insert 1. Thus, housing part 20 is cap-shaped, the internal dimensions of housing part 20 in particular being matched to the external dimensions of contact insert 1. Two pivotable locking brackets 25 are disposed laterally on housing part 20 for attachment to a corresponding second housing part of a connector.

Housing part 20 has formed therein a plurality of abutment portions 23 on which an inserted contact insert 1 rests with its shoulders 7, so that a defined end position of contact insert 1 in housing part 20 is defined by the position of abutment portions 23. Since the illustrated contact insert 1 is provided with a total of four shoulders 7, housing part 20 likewise has four abutment portions 23, which are respectively disposed outwardly on the two end walls 22, 22′, near the transition region to side walls 21, 21′. Moreover, a latching recess 24 is formed in the inner surface of each of the two end walls 22, 22′, into which recesses respective latching elements 8 engage with their latching noses 11 when in their first position.

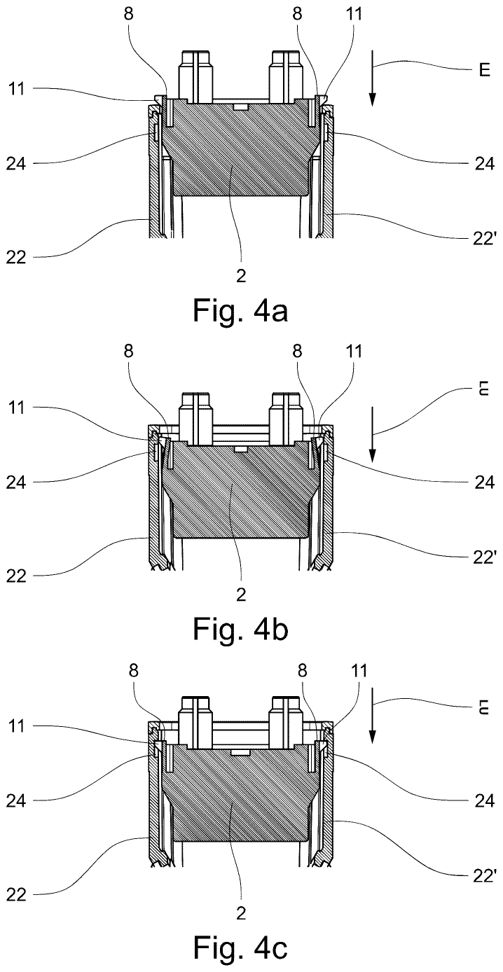

FIG. 4 shows a portion of housing part 20 with an inserted contact insert 1 in three different positions during insertion of contact insert 1 into housing part 20. When contact insert 1 is in the position shown in FIG. 4a, latching noses 11 of latching elements 8 are still located above the top edge of housing part 20 or of end walls 22, 22′, so that the latching arms are still not deflected. When contact insert 1 is inserted further into housing part 20, latching noses 11 slide along the inner surfaces of the two end walls 22, 22′, thereby deflecting latching arms 8 against their spring force, as illustrated in FIG. 4b. Once contact insert 1 is fully inserted in housing part 20, so that shoulders 7 abut abutment portions 23, latching noses 11 of latching elements 8 are located at the level of the latching recesses 24 in the inner surfaces of the two end walls 22, 22′, so that the latching arms spring back from their second position to their first position, where latching noses 11 engage in latching recesses 24. In this condition, contact insert 1 can no longer be pulled out of housing part 20 in a direction opposite to insertion direction E. To do this, latching elements 8 must first be deflected from their first position (locking position) to their second position (removal position), so that latching noses 11 no longer engage in latching recesses 24.

It can also be seen from the three views of FIG. 4 that latching noses 11 each have a bevel that rises outwardly in a direction opposite to insertion direction E, so that during insertion of contact insert 1 into housing part 20, latching noses 11 slide with their bevel along end walls 22, 22′ of housing part 20, thereby automatically deflecting the resilient latching arms with their free end 10 toward end sides 6, 6′ of insulating body 2.

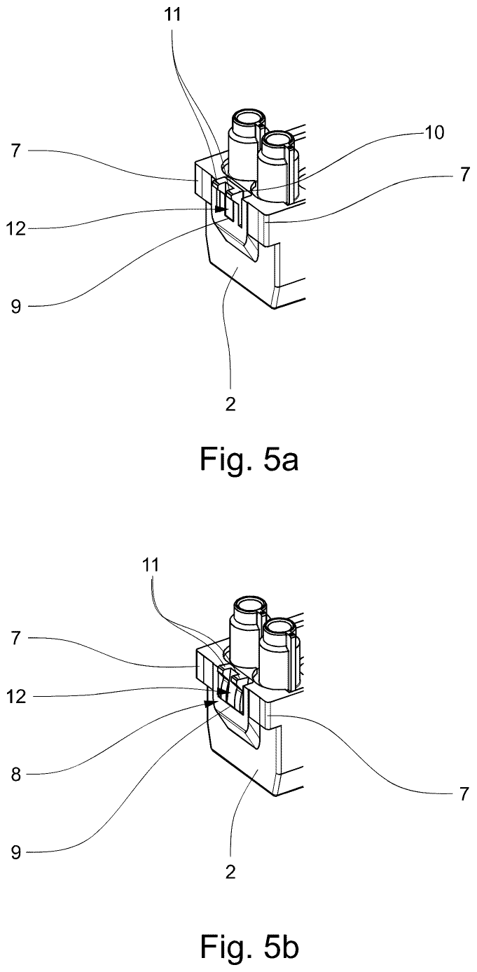

In order to allow a contact insert 1 that is inserted into and latched in place in a housing part 20 to be removed from housing part 20 when needed, the two latching elements 8 each have an actuating portion 12 configured as a receptacle for a tool. As can be seen, in particular, in the enlarged view of FIG. 5, actuating portion 12 is located between the two latching noses 11 of a latching element 8, so that latching noses 11 serve as a guide during insertion of a tool into actuating portion 12. Once the tip of a tool is inserted in actuating portion 12, latching element 8 can be easily pivoted from the latched position shown in FIG. 5a into the second position shown in FIG. 5b, so that contact insert 1 can be removed from housing part 20.

As can be seen from the various views of contact insert 1, particularly from FIGS. 1 and 5, no metal part serving as a ground terminal is disposed on any of the two end sides 6, 6′ of insulating body 2. Only the two shoulders 7 and the latching element 8 are disposed or formed on the two respective end sides 6, 6′ of insulating body 2, shoulders 7 and latching element 8 projecting only slightly outwardly from the otherwise planar end sides 6, 6′. As a result, mating face 4 of contact insert 1, which is formed by contact elements 3, has an area only slightly less than the maximum external dimension of contact insert 1. In other words, the maximum external dimensions of contact insert 1 differ from the area of mating face 4 substantially only by the dimensions of shoulders 7 and of latching elements 8. Due to this, although the external dimensions of contact insert 1 remain unchanged, more space is available for the arrangement of contact elements 3, which increases the contact density of contact insert 1 as compared to conventional contact inserts of the same size.

The illustrated contact insert 1 and the illustrated assembly composed of contact insert 1 and housing part 20 are thus reduced to what is essential. The mounting of contact insert 1 in housing part 20 is significantly simplified by the screwless, latching attachment thereof, without the need for any additional components, such as, in particular, a holding frame or separate mounting elements.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE CHARACTERS

1, 1′ contact insert
2 insulating body
3 contact elements
4, 4′ mating faces
5,5 longitudinal sides
6, 6′ end sides
7 shoulder
8 latching element
9 root portion
10 free end
11 latching nose
12 actuating portion
20 housing part
21, 21′ side walls
22, 22′ end walls
23 abutment portions
24 latching recess
25 locking bracket
E insertion direction

1. A contact insert for a connector, comprising:
an insulating body in which a plurality of contact elements are arranged, the insulating body having two mutually opposing longitudinal sides and two mutually opposing end sides;
at least one shoulder; and
at least one latching element configured to latch the contact insert in place in a housing part of a connector being disposed on each of the two mutually opposing end sides,
wherein the at least one latching element is configured to be brought from a first position into a second position.

2. The contact insert of claim 1, wherein the at least one shoulder comprises two shoulders.
wherein the two shoulders are formed on each of the two mutually opposing end sides of the insulating body, and
wherein, on both of the two mutually opposing end sides the at least one latching element is disposed between the two shoulders, and the two shoulders are disposed outwardly on respective mutually opposing end sides of the two mutually opposing end sides.

3. The contact insert of claim 1, wherein each latching element of the at least one latching elements is pivotably disposed on a mutually opposing end side of the insulating body.

4. The contact insert of claim 1, wherein the at least one shoulder and/or the at least one latching element are/is formed integrally with the insulating body.

5. The contact insert of claim 4, wherein the at least one latching element comprises at least one resilient latching arm, a root portion of each of the at least one resilient latching arm being connected to a respective mutually opposing end side of the two mutually opposing end sides and a free end of each resilient latching arm having at least one latching nose.

6. The contact insert of claim 5,
wherein each of the at least one latching element has an actuating portion configured to bring the each latching element from the first position into the second position.

7. The contact insert of claim 6, wherein the actuating portion comprises a receptacle for a tool.

8. The contact insert of claim 7, wherein each latching element has two latching noses that are spaced apart, and
wherein the receptacle is configured to receive the tool between the two latching noses.

9. The contact insert of claim 1,
wherein no metal part serving as a ground terminal is disposed at the two mutually opposing end sides of the insulating body, and
wherein a mating face of the contact insert, which is formed by the plurality of contact elements, has an area corresponding to at least 80%, of a base area of the contact insert.

10. An assembly, comprising:
the contact insert of claim 1; and
a housing part of a connector,
wherein the at least one shoulder and the at least one latching element are disposed on each of the two mutually opposing end sides
wherein the housing part has two mutually opposing side walls, two likewise mutually opposing end walls, and a plurality of abutment portions on which rest on the at least one shoulder of the contact insert when the contact insert is inserted, and
wherein a latching recess formed in an inner surface of each of the two likewise mutually opposing end walls, into each of which latching recesses engages a respective latching element of the at least one latching element in the first position of the latching element.

11. The assembly of claim 10,
wherein the contact insert comprises plastic, and
wherein the housing part comprises metal, metal alloy, or plastic.

12. The contact insert of claim 1, wherein the first position is a locking position and the second position is a removal position.

13. The contact insert of claim 6, wherein the first position is a locking position and the second position is a removal position.

14. The contact insert of claim 9, wherein the area of the mating face of the contact insert corresponds to at least 90 % of the base area of the contact insert.
